(19) United States
(12) Patent Application Publication
(10) Pub. No.: US 2010/0003893 A1
(43) Pub. Date: Jan. 7, 2010

(54) Integral honey centrifuge or extractor from frames, combs, opercula and similar, and process for honey extraction

(76) Inventor: José Vilani Oliveira, JR., Rio de Janeiro (BR)

Correspondence Address: Fildes & Outland P C, 20916 Mack Ave Ste 2, Grosse Pointe Woods, MI, 48236, US

(21) Appl. No.: 11/920,990

(22) PCT Filed: May 26, 2006
(86) PCT No.: PCT/EP2006/000101

§ 371 Date: Nov. 21, 2007

(30) Foreign Application Priority Data
May 27, 2005 (BR) PI 0503542-2

(51) Int. Cl. A01K 59/04

(52) U.S. Cl. 449/2; 449/53

(57) ABSTRACT

Patent of invention to a honey centrifuge or extractor which is comprised by a body or shield (1), with bearings to fix the set (2), basket, cage or support to the frames with honeycombs (3), exit to honey (4), cover (5), forming a single set, mono block, which rotates and may have the axis disposed vertically as well as horizontally and manual or motorized action, making the honey being extracted from the honey frames, combs, opercula, and similar to drain to the shield or body, without suffering shocks or impacts and by this manner keeping the original characteristics of the honey. Characterized by having in the upper part or in the end of the body or shield (1) of the centrifuge through which are placed the frames or honeycombs, an internal bar, brim, or edge (6) conveniently calculated and higher than the body or shield to avoid the honey, which is in the internal wall during operation, overflow and spill out from the equipment. This bar, brim or internal edge must be part of the body or shield to avoid contamination and facilitates the equipment cleanness.

The present patent of invention has as objective a rotary equipment to extract honey from combs, opercula, frames, and similar to be used in apiaries, honey warehouses, and similar, with the objective to extract the honey while keeping the same original honey characteristics and composition find in hive combs and frames, and a process to extract honey using this equipment.

It is already known and largely utilized the honey centrifuges or extractors comprised by a rotary center, a rotor, in vertical or horizontal position, composed by a principal or fixation axis, passing by the shield or body, where is provided the twist to generate the rotary movement, fixed to a basket, support or cage, where the frames containing the honey combs are placed. The frames or combs can be, related to the axis, radial or facially disposed. The body or shield involving this rotor normally has a cylinder shape, and it is static. When the rotor is operating, the frames, honeycombs and opercula rotate together, making the honey to be expelled from the combs with velocity, via centrifuge force. The honey is launched against the static wall of the body or shield, suffering a shock once the velocity goes to zero in a little space of time. The honey is pulverized in several small drops due to the impact. These kinds of centrifuges or extractors and the present state of the art were object of the requested invention Honey Extractor in Multiple Layers, BR0102325, The Improved Equipment to Extract Through Centrifugation of Bee Honey Contained in Combs Built in Frames Spaced Among Themselves With Metal Clamps, BR9302727, and Honey Extraction Centrifuge, MU7301030. All the requests above mentioned having the same functioning principle, the internal rotating rotor, composed by a central axis fixing the cages, basket or support, and the centrifuge body or shield wall, static.

Despite the large utilization of this kind of extractor, some drawbacks can be attributed to them, as for example, the honey alteration promoted by the shock that provokes honey aeration, increasing exchange surface with atmospheric air, due to the formation of several small drops of honey, causing volatile enzyme liberation, foam and micro-foam production, oxidation, humidity increase of till 1.5 percent once the honey is hygroscopic, what means more than 8% of increase over the limit established by the inspection agency, and consequently, the fermentation speedy and flavor alteration. All these drawbacks make that some honey be rejected by the inspection agency, having its price depreciated by the buyers as being a product of inferior quality.

Take into account these problems and with the purpose of their overcome, it was searched and developed a new honey centrifuge or extractor of honey frames, combs, opercula, and similar, objective of the present invention, which has a fundamental difference and consists in composing or linking the basket or support or cage to the principal or fixation axis, and finally, to the body or shield, making a single set, mono block, that rotates. The principal axis can be disposed in the vertical as well as in the horizontal, the start up can be manual or motorized, the frames or combs can be disposed, in relation to the center, in radial or facial positioning, and closed with or without a cover.

In the upper part or upper end of the centrifuge body or shield where the honey frames or combs are placed through must have a bar, brim or internal edge conveniently calculated and higher than the body or shield to avoid the honey, which is in the internal wall during operation, overflow and spill out from the equipment. This bar, brim or internal edge must be part of the body or shield to avoid contamination and facilitates the equipment cleanness.

The integral honey centrifuge or extractor way of construction solves the drawbacks pointed in its totality. The humidity increasing, foam and micro-foam production, volatile enzyme liberation, oxidation, and fermentation due to the extraction process and shock are reduced to zero. Once the equipment be functioning, the honey leaving the alveoluses, honeycombs, opercula, or similar, it drains the body or shield wall, which is also rotating, at the same velocity of frames, combs, opercula, or similar and it will be contained on the wall until the movement cease. The relative velocity between the wall, body or shield and the honey frames, combs, opercula, and similar is zero. When the centrifuge rotor stops rotating, the effect on the honey frames or combs and on the honey on the wall or shield caused by the centrifuge force ceases. The honey drains to the inferior part where is located a collector with a drain or exit for the honey. During the whole extraction or centrifugation process the honey is extracted without suffering shocks or impacts, once there is not abrupt deceleration, does not suffer neither aeration nor pulverization, keeping its total integrity, without any alteration in the flavor and preserving it for much more time, prolonging the beginning of fermentation, maintaining relative humidity and original volatile enzymes.

On the other hand the new constructive aspect makes the manufacturing and mounting simpler e economic, and mainly makes the cleanness and hygiene of the equipment simpler and easy once diminishes the amount of pieces in the interior of the equipment body or shield, and enter in contact with the product or may come to enter in contact. The bearings can be fixed on the external part of the set, getting rid of the need of having an axis passing through the internal part of the body or shield. In the manufacture of a bore in the body or shield to pass the axis, it would be necessary also seals and orings for sealing purposes, which could cause honey contamination or make difficult the hygiene and asepsis. This new constructive aspect also eliminates clamps, fixers, spacers, separators, and similar to fix or separate the honey frames once the frames stay sustained or fixed on the support correctly calculated and dimensioned in order the frames stay on the support by the way of their own weight, when the equipment is stopped, or by the way of the centrifuge force, when the equipment is moving, without dropping or falling down.

The appended drawings show the integral honey centrifuge or extractor disposition, objective of the present invention, which:

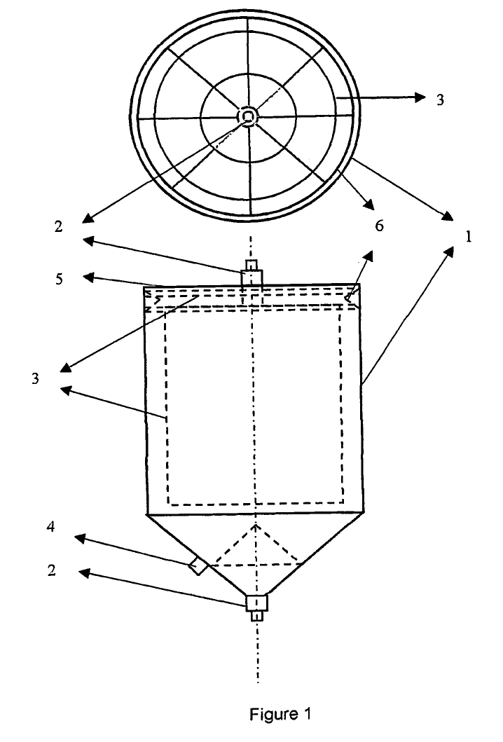

FIG. 1 shows the equipment mounted with superior and frontal views and

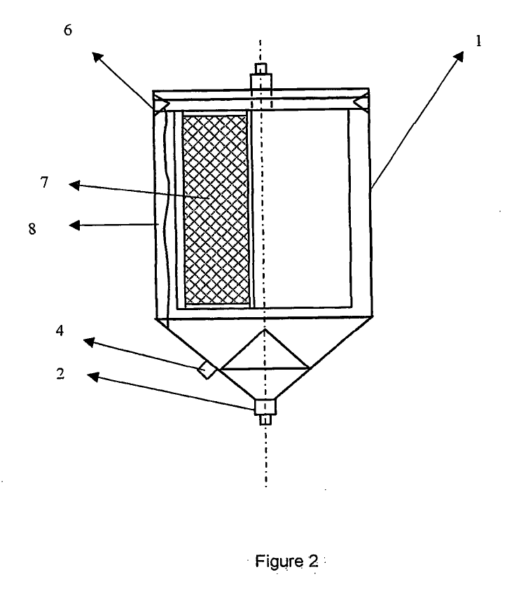

FIG. 2 shows it in a cut view during functioning.

In conformity with what is illustrated in the Figures above related, the honey centrifuge or extractor, object of the present invention, consists of a body or shield (1), with bearings to fix the set (2) the structure, basket, cage or support to the honey frames or combs (3), honey exit (4), cover (5), and the internal bar, brim or edge (6).

The frames with honeycombs not operculated (7) are placed on the support (3), disposed in a radial or facial way, the centrifuge is put to work by manual or motorized action, and after a period of functioning, the centrifuge is stopped in order to have the honey extracted (8) from the frames (7), and which are on the internal wall of the body, and was under action of the centrifuge force, drains by the way of gravity force and it is collected in the honey exit (4).

The internal bar, brim, or edge (6) avoids the honey (8), which is on the wall or shield (1) due to the action of centrifuge force during operation, to spill.

Logically, the honey extractor or centrifuge can be obtained in several sizes, capacities, and ways to be put in action to attend the user's needs of this kind of equipment.

1. INTEGRAL HONEY CENTRIFUGE OR EXTRACTOR FOR FRAMES, COMBS, OPERCULA, AND SIMILAR AND PROCESS FOR HONEY EXTRACTION, comprised by the body with bearings to fix the set, basket, cage or support to the frames with honeycombs, exit for the honey, cover, making a single set, mono block, which rotates, characterized by the fact of having in the upper part or end of the centrifuge body or shield, through which are placed the honey frames or combs, an internal bar, brim, or edge

2. INTEGRAL HONEY CENTRIFUGE OR EXTRACTOR FOR FRAMES, COMBS, OPERCULA, AND SIMILAR, according to claim 1, characterized by the fact that the set rotates at the same velocity.

3. INTEGRAL HONEY CENTRIFUGE OR EXTRACTOR FOR FRAMES, COMBS, OPERCULA, AND SIMILAR according to claim 1, characterized by the fact that the axis is disposed vertically.

4. INTEGRAL HONEY CENTRIFUGE OR EXTRACTOR FOR FRAMES, COMBS, OPERCULA, AND SIMILAR according to claim 1, characterized by the fact that the axis is disposed horizontally.

5. INTEGRAL HONEY CENTRIFUGE OR EXTRACTOR FOR FRAMES, COMBS, OPERCULA, AND SIMILAR according to claim 1, characterized by the fact that there is not clamps, fixers, separators, spacers, and similar to fix the frame to the support or to separate the frames.

6. PROCESS FOR HONEY EXTRACTION, USING THE CENTRIFUGE as defined in claim 1, characterized by the fact that the frames with the honeycombs not operculated are placed on the support, disposed in a radial or facial way, the centrifuge is started up by manual or motorized action, and after a period of function the centrifuge is stopped in order to have the honey extracted from the frames, and which is on the internal wall of the body, which was under action of the centrifuge force, drained by the action of the gravity force and is collected in the honey exit.
